(19) United States
(12) Patent Application Publication
(10) Pub. No.: US 2009/0124533 A1
(43) Pub. Date: May 14, 2009

(54) Thixotropic Fabric Softeners

(75) Inventors: Ulrike Kottke, Gelnhausen (DE); Michael Fender, Flieden (DE); Harald Jakob, Hasselroth (DE); Kurt Seidel, Jossgrund (DE); Ellen Reuter, Bochum (DE); Eberhard Esselborn, Essen (DE)

Correspondence Address: LAW OFFICE OF MICHAEL A. SANZO, LLC, 15400 CALHOUN DR., SUITE 125, ROCKVILLE, MD, 20855, US

(73) Assignee: Evonik Degussa GmbH, Essen (DE)

(21) Appl. No.: 12/226,636

(22) PCT Filed: Apr. 4, 2007
(86) PCT No.: PCT/EP2007/053302

§ 371 Date: Oct. 23, 2008

(30) Foreign Application Priority Data
Apr. 27, 2006 (EP) EP06113229

(51) Int. Cl. C11D 3/37

(52) U.S. Cl. 510/527

(57) ABSTRACT

The invention relates to an aqueous fabric softener which comprises at least one textile-softening quaternary ammonium salt and at least one polyurethane thickener, and has reversibly thixotropic flow behaviour.

The inventive fabric softeners feature little change in the viscosity during storage.

The invention is directed to viscous aqueous fabric softeners.

Aqueous fabric softeners are typically added to the last rinse cycle when laundry is washed in a washing machine in order to impart a softer feel to the laundry. Such fabric softeners typically comprise textile-softening quaternary ammonium salts in an amount of 2 to 20% by weight as active components, dispersed in an aqueous solution. Without further additives, fabric softeners having a content of active components of up to 10% by weight usually have only a low viscosity and are therefore difficult to dose in use. Moreover, consumers assess the effectiveness of a fabric softener generally by its viscosity and judge a more highly viscous fabric softener to be more effective. However, an excessively high viscosity is undesired, since it leads to incomplete flushing into the washing machine in use. There is therefore a need for aqueous fabric softeners with an increased, accurately predetermined viscosity.

The prior art has proposed increasing the viscosity of an aqueous fabric softener by adding thickeners.

EP 0 051 983 discloses increasing the viscosity of aqueous fabric softeners by the addition of non-ionic or weakly anionic polymeric thickeners. Suitable polymers which are mentioned are modified celluloses, guar gum and modified guar gum, polyacrylamides and polyvinyl acetates. With 0.08 to 0.3% by weight of guar gum, thickened fabric softeners were obtained whose viscosity changed only slightly upon storage at 20° C. However, guar gum and modified celluloses have the disadvantage that they have to be swollen and dissolved before the preparation of the fabric softener. In these solutions, microbial degradation of the thickener proceeds readily which leads to a decrease in the viscosity. Therefore, the viscosity of the finished fabric softener cannot be predetermined reliably with these thickeners.

EP 0 385 749 discloses increasing the viscosity of aqueous fabric softeners by the addition of hydrophobically modified non-ionic polymers which have a hydrophilic chain. Suitable polymers which are mentioned are hydrophobically modified polyoxyalkylenes or polyvinyl alcohols. Example 2 discloses thickening with the polyurethane polymer Acrysol RM-825™ sold by Rohm and Haas.

U.S. Pat. No. 6,881,716 discloses fabric softeners which comprise an oligomeric ester quat and a thickener which is selected from ethoxylated and/or propoxylated cellulose, ethoxylated and/or propoxylated C₁₀₋₁₅ fatty alcohol or an ethoxylated and/or propoxylated fatty alcohol polyurethane. As a suitable thickener, mention is made of the polyurethane polymer Accusol 880™ sold by Rohm and Haas.

WO 00/04118 discloses fabric softeners which comprise a quaternary ammonium salt and a fatty alcohol ethoxylate diurethane polymer as a thickener. Suitable thickeners which are mentioned are BASF products with code numbers 71495, 71496 and 71497.

For the production of the aqueous fabric softeners, it is advantageous when the fabric softener, during the mixing and filling, has a lower viscosity than the desired viscosity of the end product. Moreover, it is desirable that the viscosity of the fabric softener no longer changes during storage in order that there can be quality control of the viscosity of the product produced in the production and the quality of the product no longer changes during storage.

It has now been found that these objects can be achieved by aqueous fabric softeners which comprise a polyurethane thickener and have reversibly thixotropic flow behaviour.

The invention therefore provides aqueous fabric softeners which comprise at least one textile-softening quaternary ammonium salt and at least one polyurethane thickener and which have reversibly thixotropic flow behaviour.

Thixotropic flow behaviour of a fabric softener means that the viscosity of the fabric softener decreases in the event of shear stress and rises again after the shear stress has ended. Reversibly thixotropic flow behaviour in the context of the invention is present when the viscosity of the fabric softener decreases in the event of shear stress and, after the shear stress has ended, rises again to at least 90% of the starting value within a short time, i.e. generally less than one hour.

The inventive fabric softeners preferably have an at-rest viscosity in the linear-viscoelastic range of more than 100 mPa·s, the viscosity being measured according to DIN 53019 in a rotary viscometer with cylindrical geometry. The linear-viscoelastic range is the range of small shear stresses in which the elastic component G′ of the complex shear modulus is independent of the shear stress. At a shear stress of 30 Pa, the viscosity of these preferred fabric softeners decreases to less than 30% of the at-rest viscosity and, after the shear stress has ended, rises again to more than 80% of the at-rest viscosity within less than 10 minutes. Particular preference is given to fabric softeners in which the viscosity, at a shear stress of 30 Pa, decreases to less than 20% of the at-rest viscosity and, after the shear stress has ended, rises again to more than 90% of the at-rest viscosity within less than 10 minutes.

When the viscosity is determined with a Brookfield viscometer (spindle LVT No. 2, rotational speed 30 min⁻¹), the inventive fabric softeners preferably have a viscosity in the range of 200 to 3000 mPa·s, more preferably in the range of 400 to 1500 mPa·s.

In the context of the invention, polyurethane thickeners are polymers with thickening action in aqueous solution and whose polymer structure is obtained by polyaddition from diisocyanates and diols. Such polyurethane thickeners and their preparation are known to those skilled in the art from the prior art, for example from U.S. Pat. No. 4,155,892.

The flow behaviour of the fabric softener is determined essentially by the structure of the polyurethane thickener. Further factors which can influence the flow behaviour are, however, also the type and amount of the quaternary ammonium salts, and the type and amount of further additives, especially of salts and acidic components. If the desired reversibly thixotropic flow behaviour is not achieved with a polyurethane thickener in the desired composition of the fabric softener, the person skilled in the art can arrive at an inventive fabric softener with reversibly thixotropic flow behaviour by one or more of the following changes in the structure of the polyurethane thickener:
introduction of two or more substituents with a long-chain alkyl radical into the polyurethane.
preparation of the polyurethane from a sterically less demanding diisocyanate.
preparation of the polyurethane from a polyalkylene glycol with higher molecular weight.

The inventive fabric softeners preferably comprise a polyurethane thickener which is an addition product of a diisocyanate with a polyalkylene glycol, the addition product bearing a C₁₄-C₂₀-alkyl radical at each chain end. The diisocyanate is preferably an aliphatic diisocyanate and is more preferably selected from hexamethylene diisocyanate, isophorone diisocyanate and dicyclohexylmethylene diisocyanate. The polyalkylene glycol preferably comprises more than 80 mol % of ethylene oxide monomer units and preferably has a molecular weight of at least 3000 g/mol. The alkyl radical is bonded to the chain ends preferably in the form of an R¹—NH—C(═O)O— group, where R¹ is the C₁₄-C₂₀-alkyl radical.

Quaternary ammonium salts with textile-softening action and their preparation are known to those skilled in the art from the prior art.

The inventive fabric softeners preferably comprise quaternary ammonium salts of the formula (I)

R²₄₋ₘN⁺(CH₂)ₙ-Q-R³]ₘX⁻, (I)

in which the R² groups are each independently C₁-C₆-alkyl, C₁-C₆-hydroxyalkyl or benzyl,
the R³ groups are each independently hydrogen or linear or branched C₁₁-C₂₂-alkyl or -alkenyl, where at least one of the R³ radicals is not hydrogen,
the Q groups are each independently selected from groups of the formulae —O—C(O)—, —C(O)O—, —NR⁴—C(O)—, —C(O)—NR⁴—, —O—C(O)—O—, —CHR⁵—O—C(O)— or —CH(OCOR³)—CH₂—O—C(O)—, where R⁴ is hydrogen, methyl, ethyl, propyl or butyl and R⁵ is hydrogen or methyl,
m is 1 to 4,
n is 1 to 4,
and X⁻ is an anion suitable for fabric softeners.

Anions suitable for fabric softeners are in particular chloride, bromide, methylsulphate, ethylsulphate, sulphate and nitrate.

Particular preference is given to compounds of the formula (I) in which R² is methyl, Q is —O—C(O)— or —NH—C(O)—, m is 2 or 3, n is 2 and X⁻ is chloride or methylsulphate. Preference is given to using these compounds in the form of mixtures, and compounds contain an average of 1.2 to 2.5 R³ groups which are not hydrogen. More preferably, the proportion of non-hydrogen R³ groups is an average of 1.4 to 2.0, most preferably 1.6 to 1.9.

Preferred compounds of the formula (I) are quaternary ammonium salts of the formulae (II) to (IV)

R⁶N⁺[CH₂CHR⁸OH][CH₂CHR⁸OC(O)R⁷]₂ X⁻ (II)

R⁶₂N⁺[CH₂CHR⁸OC(O)R⁷]₂ X⁻ (III)

R⁶N⁺[CH₂CHR⁸OH][CH₂CH₂NHC(O)R⁷]₂ X⁻ (IV)

where the R⁶ groups are each independently C₁-C₆-alkyl, C₁-C₆-hydroxyalkyl or benzyl,
the R⁷ groups are each independently linear or branched C₁₁-C₂₂-alkyl or -alkenyl, and
the R⁸ groups are hydrogen or methyl.

In these formulae, the —C(O)R⁷ group is preferably a fatty acid radical. Suitable fatty acids are obtainable from natural triglycerides, preferably from tallow, vegetable oils, partly hydrogenated tallow or partly hydrogenated vegetable oils. Suitable sources for triglycerides are, for example, soya oil, tallow, partly hydrogenated tallow, palm oil, palm kernel oil, rapeseed oil, coconut oil, sunflower oil, corn oil, rice oil and tall oil. The fatty acids from natural sources are generally mixtures of unbranched and branched, and saturated and unsaturated aliphatic fatty acids. In order to adjust the properties of the fabric softener, such as softening action and rewetting capacity of the treated fabric, it is possible to use fatty acids obtained from different natural sources in a mixture. The proportion of unsaturated fatty acid radicals R⁷ is preferably at least 10%, more preferably at least 25% and in particular 40% to 70%. The proportion of polyunsaturated R⁷ groups is preferably less than 10%, more preferably less than 5% and in particular less than 3%. If required, the proportion of polyunsaturated fatty acid radicals can be reduced by partial hydrogenation in order to improve the storage stability of the product with regard to colour change and odour evolution. The proportion of unsaturated fatty acid radicals, expressed as the iodine number of the free fatty acid, is preferably in the range of an iodine number of 5 to 150, more preferably 5 to 50. In the unsaturated fatty acid radicals, the ratio of cis- and trans-isomers of the double bonds is preferably greater than 1:1 and more preferably in the range of 4:1 to 50:1.

Preference is likewise given to quaternary ammonium salts of the formulae (V) to (VII)

R⁶₂R⁷₂N⁺X⁻ (V)

[R⁷—C(O)NHCH₂CH₂]₂N⁺R⁶[CH₂CH₂OH]X⁻ (VI)

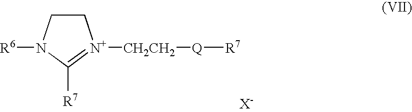

where the R⁶, R⁷ and X radicals are each as defined for the formulae (II) to (IV) and Q is —O—C(O)— or —NH—C(O)—.

The inventive aqueous fabric softeners preferably contain one or more quaternary ammonium salts in a total amount of 2 to 10% by weight, more preferably 2 to 6% by weight, and one or more polyurethane thickeners in a total amount of 0.001 to 2% by weight, more preferably 0.005 to 1% by weight and in particular 0.005 to 0.5% by weight.

The inventive aqueous fabric softeners may additionally comprise further additives which are known to those skilled in the art for the formulation of fabric softeners, especially the additives known from U.S. Pat. No. 6,737,392, column 8, line 1 to column 14, line 6.

The examples which follow illustrate the invention but without restricting its subject-matter.

### EXAMPLES

### Production of the Aqueous Fabric Softeners

Water was initially charged at 35° C. with the dye Sandolan Walkblau NBL 150 (manufacturer: Clariant, 0.15% by weight based on the total amount of fabric softener). Rewoquat WE 18 (partly hydrogenated methyltris(hydroxyethyl)ammonium ditallow fatty acid ester methosulphate, 90% by weight in isopropanol) heated to 50° C. was added in the amount specified while stirring at 500 revolutions/min. The resulting dispersion was stirred at 620 revolutions/min for a further 20 min. The mixture was then cooled and, at 30° C., 0.2% by weight of Skyline DW 10557 perfume oil (manufacturer: Symrise) was added. After cooling to room temperature, the thickener was added and the dispersion was stirred at 520 revolutions/min for 10 min.

The Following Thickeners were Used:

Tego Visco Plus 3030™ (polyurethane thickener, polymer content 60% by weight), manufacturer: Degussa AG
Accusol 880™ (polyurethane thickener, polymer content 35% by weight), manufacturer: Rohm and Haas
Acrysol RM-8W™, (polyurethane thickener, polymer content 17.5% by weight), manufacturer: Rohm and Haas
Acrysol RM-825™, (polyurethane thickener, polymer content 25% by weight), manufacturer: Rohm and Haas

The compositions of the aqueous fabric softeners produced are listed in Table 1.

TABLE 1
Compositions of the fabric softeners (the remainder to
100% by weight is water, dye and perfume oil)

| | | Tego | | | |
|---|---|---|---|---|---|
| | Rewoquat | Visco | Accusol | Acrysol | Acrysol |
| | WE 18 | Plus 3030 | 880 | RM-8W | RM-825 |
| Example | [% by wt] | [% by wt] | [% by wt] | [% by wt] | [% by wt] |
| 1 | 3 | 0.1 | — | — | — |
| 2 | 3 | 0.25 | — | — | — |
| 3 | 3 | 0.5 | — | — | — |
| 4* | 3 | — | 0.17 | — | — |
| 5* | 3 | — | 0.43 | — | — |
| 6* | 3 | — | 0.86 | — | — |
| 7 | 4 | 0.5 | — | — | — |
| 8* | 4 | — | 0.86 | — | — |
| 9* | 4 | — | — | 1.7 | — |
| 10* | 4 | — | — | — | 1.2 |
| 11 | 5 | 0.1 | | | |
| 12 | 5 | 0.05 | — | — | — |
| 13 | 5 | 0.025 | — | — | — |
| 14* | 5 | — | 0.17 | — | — |
| 15* | 5 | — | 0.085 | — | — |
| 16* | 5 | — | 0.043 | — | — |

*not according to the invention

### Determination of the Flow Behaviour

The thixotropic flow behaviour was determined with a Stresstech rotary viscometer from Reologica. The measurements were effected with cylindrical geometry by oscillating measurement at an oscillation frequency of 1 Hz in an EMB-Z3 test cup of internal diameter 26.5 mm using a CC25 oscillating cylinder of external diameter 25 mm. At 23° C., in immediate succession, measurements were made at a shear stress of 0.2 Pa for 300 s, at a shear stress of 30 Pa for 120 s and at a shear stress of 0.2 Pa for 900 s. Control measurements at the same oscillation frequency, in which the viscosity was determined as a function of the shear stress, ensured that the measurement with a shear stress of 0.2 Pa was effected in all samples in the linear-viscoelastic range.

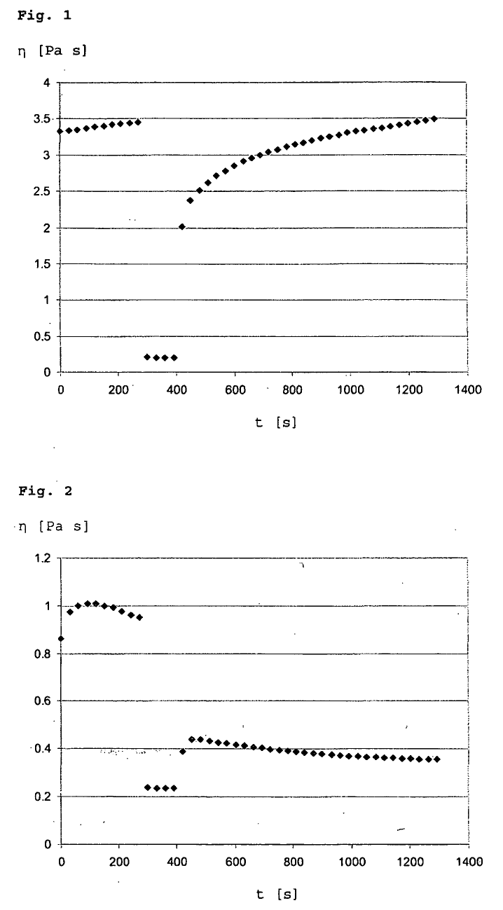

The results of the measurements are reproduced in Table 2 and FIG. 1 to 4.

TABLE 2
Viscosity before shear stress (0-300 s), under shear stress**
(300-420 s) and after shear stress (420-1200 s).

| | Example 7 | Example 8* | Example 9* | Example 10* |
|---|---|---|---|---|
| t [s] | Viscosity η [Pa · s] | | | |
| 1 | 3.32 | 0.864 | 1.05 | 1.07 |
| 62 | 3.35 | 1.00 | 1.23 | 0.976 |
| 121 | 3.39 | 1.01 | 1.30 | 0.950 |
| 182 | 3.42 | 0.992 | 1.34 | 0.939 |
| 271 | 3.45 | 0.952 | 1.38 | 0.957 |
| 301** | 0.211** | 0.240** | 0.269** | 0.221** |
| 362** | 0.200** | 0.236** | 0.243** | 0.218** |
| 421 | 2.02 | 0.388 | 0.752 | 0.465 |
| 482 | 2.51 | 0.438 | 0.789 | 0.465 |
| 541 | 2.71 | 0.427 | 0.775 | 0.444 |
| 602 | 2.85 | 0.418 | 0.760 | 0.409 |
| 662 | 2.96 | 0.409 | 0.749 | 0.411 |
| 842 | 3.17 | 0.384 | 0.710 | 0.377 |
| 1020 | 3.32 | 0.368 | 0.689 | 0.362 |
| 1200 | 3.43 | 0.359 | 0.668 | 0.366 |

*not according to the invention

FIG. 1: Example 7 (according to the invention)

FIG. 2: Example 8 (not according to the invention)

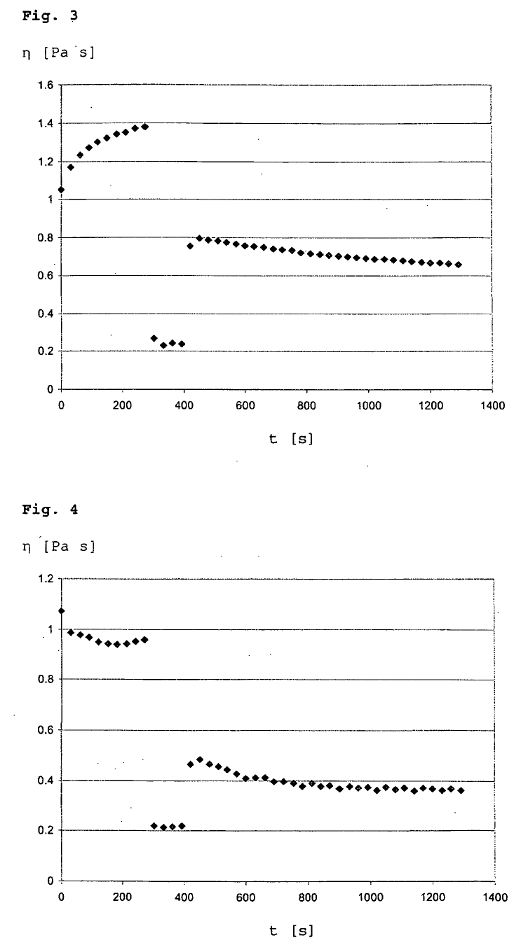

FIG. 3: Example 9 (not according to the invention)

FIG. 4: Example 10 (not according to the invention)

### Determination of the Storage Stability

To determine the storage stability, the viscosity was determined at room temperature within 0.5 h after production and after 12 weeks of storage. The viscosity was measured with a Brookfield viscometer at 20° C. with spindle LVT No. 2 at a rotational speed of 30 min⁻¹.

The results of the measurements are reproduced in Table 3.

TABLE 3
Viscosity before and after 12 weeks of storage

| | Viscosity after | Viscosity after | Viscosity |
|---|---|---|---|
| | production | storage | change |
| Example | [mPa · s] | [mPa · s] | [%] |
| 1 | 235 | 265 | +13 |
| 2 | 410 | 420 | +2 |
| 3 | 510 | 560 | +10 |
| 4* | 325 | 210 | −35 |
| 5* | 345 | 280 | −19 |
| 6* | 950 | 480 | −49 |
| 11 | 745 | 880 | +18 |
| 12 | 530 | 620 | +17 |
| 13 | 375 | 340 | −9 |
| 14* | 760 | 300 | −61 |
| 15* | 740 | 320 | −57 |
| 16* | 430 | 265 | −38 |

*not according to the invention

The inventive fabric softeners comprising a polyurethane thickener which brings about reversibly thixotropic flow behaviour exhibit good stability of viscosity, which changes only slightly compared to the viscosity immediately after production during storage over 12 weeks. With these fabric softeners it is possible to ensure that the product reaches the consumer with a predetermined viscosity by a quality control after production. The fabric softeners with a polyurethane thickener known from the prior art, which does not bring about reversibly thixotropic flow behaviour, exhibit a greater change in the viscosity during storage. In the case of these, the viscosity with which the product reaches the consumer cannot be predetermined.

1-9. (canceled)

10. An aqueous fabric softener comprising at least one textile-softening quaternary ammonium salt and at least one polyurethane thickener, wherein said fabric softener has reversible thixotropic flow behavior.

11. The fabric softener of claim 10, wherein said fabric softener has an at-rest viscosity in the linear-viscoelastic range of more than 100 mPa·s, the viscosity decreases to less than 30% of the at-rest viscosity at a shear stress of 30 Pa and, after the shear stress has ended, rises again to more than 80% of the at-rest viscosity within less than 10 minutes, the viscosities being measured according to DIN 53019 in a rotary viscometer with cylindrical geometry.

12. The fabric softener of claim 10, wherein said fabric softener comprises quaternary ammonium salts in an amount of 2 to 10% by weight and polyurethane thickeners in an amount of 0.001 to 2% by weight.

13. The fabric softener of claim 10, wherein said fabric softener comprises quaternary ammonium salts in an amount of 2 to 6% by weight and polyurethane thickeners in an amount of 0.005 to 0.5% by weight.

14. The fabric softener of claim 10, wherein the polyurethane is an addition product of a diisocyanate with a polyalkylene glycol which bears a C₁₋₄-C₂₀-alkyl radical at each chain end.

15. The fabric softener of claim 14, wherein the diisocyanate is selected from the group consisting of: hexamethylene diisocyanate; isophorone diisocyanate; and dicyclohexylmethylene diisocyanate.

16. The fabric softener of claim 14, wherein the polyurethane comprises an R¹—NH—C(═O)O— group at each chain end, where R¹ is a C₁₄-C₂₀-alkyl radical.

17. The fabric softener of claim 10, wherein said fabric softener comprises a quaternary ammonium salt of the formula (I):
R²₄₋ₘN⁺[(CH₂)ₙ-Q-R³]ₘX⁻, (I)
in which the R² groups are each independently C₁-C₆-alkyl, C₁-C₆-hydroxyalkyl or benzyl,
the R³ groups are each independently hydrogen or linear or branched C₁₁-C₂₂-alkyl or -alkenyl, where at least one of the R³ radicals is not hydrogen,
the Q groups are each independently selected from groups of the formulae —O—C(O)—, —C(O)O—, —NR⁴—C(O)—, —C(O)—NR⁴—, —O—C(O)—O—, —CHR⁵—O—C(O)— or —CH(OCOR³)—CH₂—O—C(O)—, where R⁴ is hydrogen, methyl, ethyl, propyl or butyl and R⁵ is hydrogen or methyl,
m is 1 to 4,
n is 1 to 4,
and X⁻ is an anion suitable for fabric softeners.

18. The fabric softener of claim 17, wherein the polyurethane is an addition product of a diisocyanate with a polyalkylene glycol which bears a C₁₄-C₂₀-alkyl radical at each chain end.

19. The fabric softener of claim 18, wherein the diisocyanate is selected from the group consisting of: hexamethylene diisocyanate; isophorone diisocyanate; and dicyclohexylmethylene diisocyanate.

20. The fabric softener of claim 18, wherein the polyurethane comprises an R¹—NH—C(═O)O— group at each chain end, where R¹ is a C₁₄-C₂₀-alkyl radical.

21. The fabric softener of claim 17, wherein said fabric softener comprises quaternary ammonium salts in an amount of 2 to 10% by weight and polyurethane thickeners in an amount of 0.001 to 2% by weight.

22. The fabric softener of claim 17, wherein said fabric softener has an at-rest viscosity in the linear-viscoelastic range of more than 100 mPa·s, the viscosity decreases to less than 30% of the at-rest viscosity at a shear stress of 30 Pa and, after the shear stress has ended, rises again to more than 80% of the at-rest viscosity within less than 10 minutes, the viscosities being measured according to DIN 53019 in a rotary viscometer with cylindrical geometry.

23. The fabric softener of claim 17, wherein R² in formula (I) is methyl, Q is —O—C(O)— or —NH—C(O)—, m is 2 or 3, n is 2 and X⁻ is chloride or methylsulphate.

24. The fabric softener of claim 10, wherein said fabric softener comprises a quaternary ammonium salt selected from compounds of formulae (II) to (VII):
R⁶N⁺[CH₂CHR⁸OH][CH₂CHR⁸OC(O)R⁷]₂ X⁻ (II)
R⁶₂N⁺[CH₂CHR⁸OC(O)R⁷]₂ X⁻ (III)
R⁶N⁺[CH₂CHR⁸OH][CH₂CH₂NHC(O)R⁷]₂ X⁻ (IV)
R⁶₂R⁷₂N⁺X⁻ (V)
[R⁷—C(O)NHCH₂CH₂]₂N⁺R⁶[CH₂CH₂OH]X⁻ (VI) 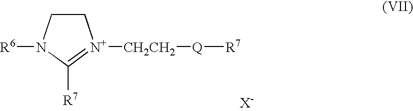
wherein the R⁶ groups are each independently C₁-C₆-alkyl, C₁-C₆-hydroxyalkyl or benzyl,
the R⁷ groups are each independently linear or branched C₁₁-C₂₂-alkyl or -alkenyl,
the R⁸ groups are hydrogen or methyl,
Q is —O—C(O)— or —NH—C(O)—, and X⁻ is an anion suitable for fabric softeners.

25. The fabric softener of claim 24, wherein the polyurethane is an addition product of a diisocyanate with a polyalkylene glycol which bears a C₁₄-C₂₀-alkyl radical at each chain end.

26. The fabric softener of claim 25, wherein the diisocyanate is selected from the group consisting of: hexamethylene diisocyanate; isophorone diisocyanate; and dicyclohexylmethylene diisocyanate.

27. The fabric softener of claim 25, wherein the polyurethane comprises an R—NH—C(═O)O— group at each chain end, where R¹ is a C₁₄-C₂₀-alkyl radical.

28. The fabric softener of claim 24, wherein said fabric softener comprises quaternary ammonium salts in an amount of 2 to 10% by weight and polyurethane thickeners in an amount of 0.001 to 2% by weight.

29. The fabric softener of claim 14, wherein said fabric softener has an at-rest viscosity in the linear-viscoelastic range of more than 100 mPa·s, the viscosity decreases to less than 30% of the at-rest viscosity at a shear stress of 30 Pa and, after the shear stress has ended, rises again to more than 80% of the at-rest viscosity within less than 10 minutes, the viscosities being measured according to DIN 53019 in a rotary viscometer with cylindrical geometry.
